(19) United States
(12) Patent Application Publication
(10) Pub. No.: US 2014/0374511 A1
(43) Pub. Date: Dec. 25, 2014

(54) HOLDER FOR SUPPORTING NOZZLE

(71) Applicant: Hon Hai Precision Industry Co., Ltd., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/961,713

(22) Filed: Aug. 7, 2013

(30) Foreign Application Priority Data
Jun. 25, 2013 (TW) 102122594

(51) Int. Cl. B05B 15/08

(52) U.S. Cl. CPC B05B 15/08
USPC 239/536

(57) ABSTRACT

A holder assembly for supporting nozzle includes a holder having a plurality of fixing members; a plurality of sliding members, each sliding member being fixed on the holder by one of the fixing members, each sliding member being rotatable and slidable relative to the holder before being fixed by the one of the fixing members; and a plurality of nozzles, each nozzle being arranged on one of the sliding members, the positions of the nozzles being changeable when the slide members being rotated or sliding relative to the fixing members.

### BACKGROUND

1. Technical Field

The disclosure relates to a holder for supporting nozzles.

2. Description of Related Art

Injection molding is a manufacturing process for producing parts by injecting material into a mold. Injection molding consists of high pressure injection of the raw material into a mold which shapes the raw material into the desired shape to obtain a die. Molds can include a single cavity or multiple cavities. In the mold having multiple cavities, multiple dies are formed in a predetermined arrangement such as a matrix or a line, after injection molding. Nozzles are then needed to absorb the desired dies from the mold. The nozzles are supported by a holder in a fixed manner. However, the dies may be arranged with various shapes; therefore, it requires various holders to support the nozzles in different ways corresponding to the various arrangements of the dies. Thus, the process is complicated and makes the manufacture of the dies costly.

Therefore, what is needed is a holder for supporting nozzles which can overcome the above-described shortcomings.

### BRIEF DESCRIPTION OF THE DRAWINGS

FIG. 1 is an isometric view of a holder assembly for supporting nozzles in accordance with an exemplary embodiment of the present disclosure.

FIG. 2 is a front view of the holder assembly of FIG. 1, wherein nozzles are arranged in a shape of rectangle.

FIG. 3 is similar to FIG. 2, but showing the nozzles of arranged in a line.

### DETAILED DESCRIPTION

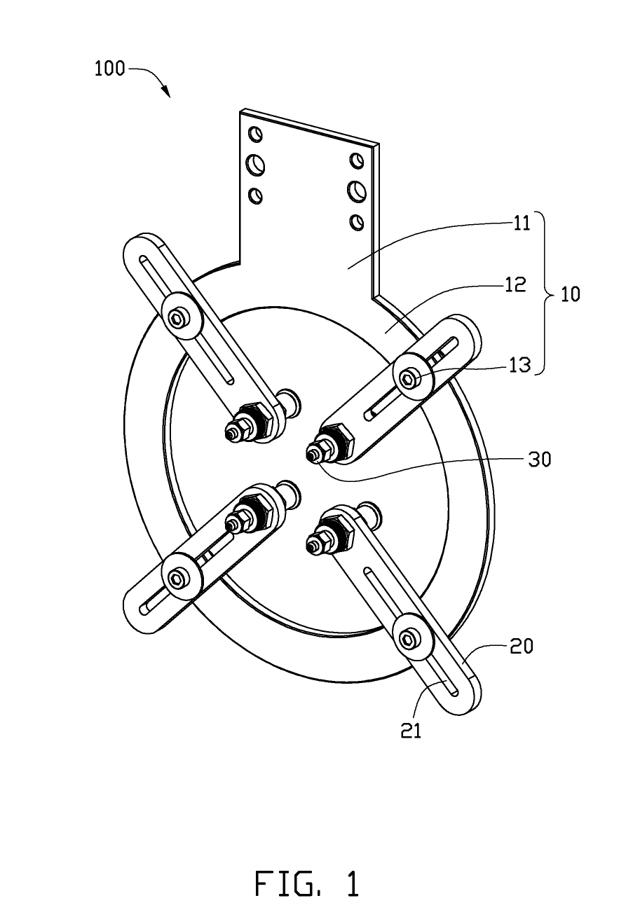

Referring to FIG. 1, an exemplary embodiment of a holder assembly for supporting nozzles 100 is shown. The holder assembly for supporting nozzle 100 includes a holder 10, a plurality of sliding members 20, and a plurality of nozzles 30.

The holder 10 includes a circle supporting member 12, a connecting member 11 extending outwardly from the supporting member 12 to connect an external device such as a bracket, and a plurality of fixing members 13 arranged on the supporting member 12. In the present embodiment, the fixing members 13 are four and evenly arranged on the supporting member 12. The fixing member 13 can be a screw. It can be understood that the fixing members 13 is not limited four, it can be two, three, or more than four.

In the present embodiment, the sliding members 20 are four, and each sliding member 20 is fixed on the supporting member 12 of the holder 10 by the fixing member 13. The sliding member 20 can be rotated and slide related to the supporting member 12. In the present embodiment, each sliding member 20 has a groove 21. In the present embodiment, the sliding member 20 is an elongate strip, and defines the groove 21 thereon. The groove 21 is arranged along a longitudinal direction of the sliding member 20, and the corresponding fixing member 13 is extended through and clipped on the groove 21. In the present embodiment, the four sliding members 20 are identical, and the four grooves 21 are also identical. It can be understood that the sliding members 20 is not limited four, it can be two, three, or more than four.

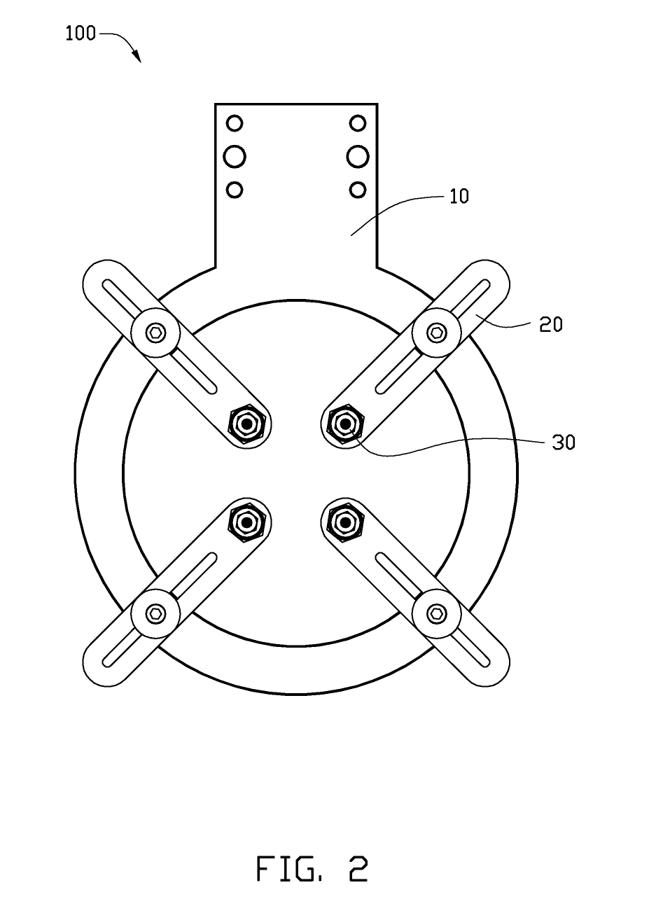

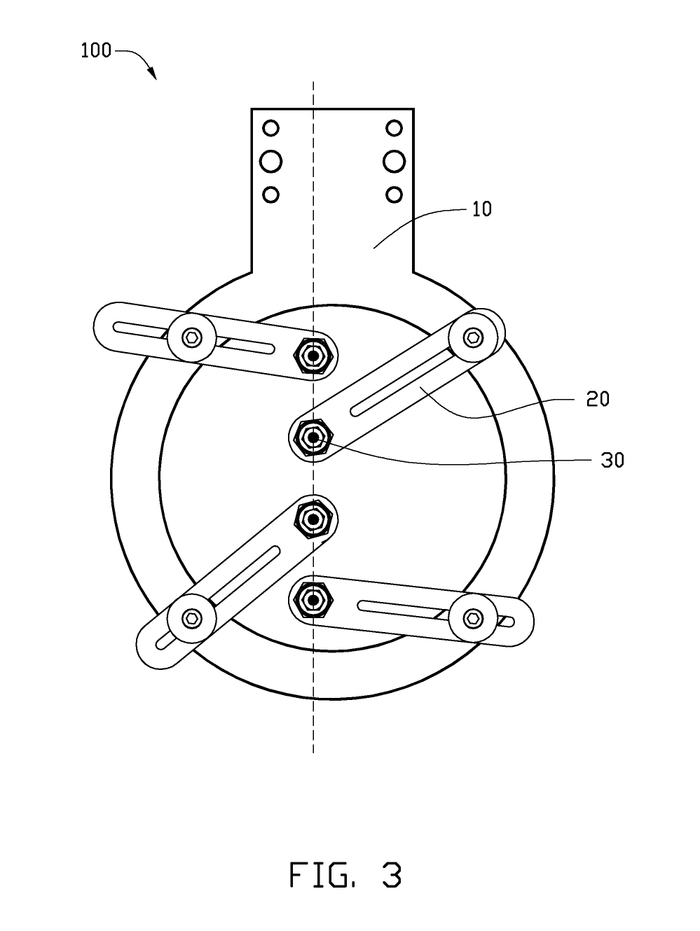

In the present embodiment, the nozzles 30 are four, and each nozzle 30 is arranged on an end portion of a corresponding sliding member 20. The slide member 20 is movable related to the fixing member 13, the related position of the corresponding nozzle 30 is changeable corresponding to movement of the slide member 20. When the nozzle 30 is moved to a desired position, the corresponding fixing member 13 is fastened to fix the corresponding sliding member 20; therefore, the position of the nozzle 30 is fixed. Referring to FIG. 2 also, the four nozzles 30 are arranged in a shape of rectangle. Referring to FIG. 3 also, the four nozzles 30 are arranged in a line.

It can be understood that the relation positions of the four nozzles 30 can be changed freely in other shapes according to the demand; therefore, it does not need to use a new holder when the positions of nozzles are changed.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A holder assembly for supporting nozzles, comprising:
a holder having a plurality of fixing members;
a plurality of sliding members, each sliding member being fixed on the holder by one of the fixing members, each sliding member being rotatable and slidable relative to the holder before being fixed by the one of the fixing members; and
a plurality of nozzles, each nozzle being arranged on one of the sliding members, the positions of the nozzles being changeable when the slide members being rotated or sliding relative to the fixing members.

2. The holder assembly for supporting nozzles of claim 1, wherein the holder comprises a circle supporting member, the fixing members being arranged on the supporting member.

3. The holder assembly for supporting nozzles of claim 2, wherein the fixing members are evenly arranged on the supporting member.

4. The holder for supporting nozzle of claim 1, wherein each sliding member comprises a groove, the corresponding fixing member extending through the groove into the supporting member.

5. The holder assembly for supporting nozzles of claim 4, wherein the groove is arranged along a longitudinal direction of the sliding member.

6. The holder assembly for supporting nozzles of claim 5, wherein the length of grooves are identical.

7. The holder assembly for supporting nozzles of claim 1, wherein the length of sliding members are identical.

8. The holder assembly for supporting nozzles of claim 1, wherein the fixing member comprises a screw.

9. The holder assembly for supporting nozzles of claim 1, wherein the nozzles are four, and the nozzles are arranged in a shape of rectangle.

10. The holder assembly for supporting nozzles of claim 1, wherein the nozzles are four, and the nozzles are arranged in a line.

11. A holder assembly for supporting nozzles comprising:
a holder;
a plurality of sliding members arranged on the holder, the sliding member being rotatable and slidable relative to the holder; and
a plurality of nozzles, each nozzle being arranged on one of the sliding members, the positions of the nozzles being changeable when the sliding members being rotated or sliding relative to the holder.

12. The holder assembly for supporting nozzles of claim 11, wherein the holder comprises a plurality of fixing members, and each sliding member is fixed on the holder by one of the fixing members.

13. The holder assembly for supporting nozzles of claim 12, wherein the holder comprises a circle supporting member, the fixing members being evenly arranged on the supporting member.

14. The holder for supporting nozzle of claim 12, wherein each sliding member comprises a groove, the corresponding fixing member extending through the groove into the supporting member.

15. The holder assembly for supporting nozzles of claim 14, wherein the groove is arranged along a longitudinal direction of the sliding member.
